(19) United States
(12) Patent Application Publication
(10) Pub. No.: US 2014/0119460 A1
(43) Pub. Date: May 1, 2014

(54) METHOD AND DEVICE FOR ASSESSING PACKET DEFECT CAUSED DEGRADATION IN PACKET CODED VIDEO

(71) Applicants: Xiao Dong Gu, Beijing (CN); Ning Liao, Beijing (CN); Zhibo Chen, Beijing (CN)

(72) Inventors: Xiao Dong Gu, Beijing (CN); Ning Liao, Beijing (CN); Zhibo Chen, Beijing (CN)

(73) Assignee: THOMSON LICENSING, Issy de Moulineaux (FR)

(21) Appl. No.: 14/128,623

(22) PCT Filed: Jun. 24, 2011
(86) PCT No.: PCT/CN2011/076277

§ 371 Date: Dec. 22, 2013

(51) Int. Cl. H04N 19/89

(52) U.S. Cl. CPC H04N 19/00933
USPC 375/240.27

(57) ABSTRACT

Because of the encoding, decoding, and/or transmitting characteristic, the blocks affected by packet defect usually gather in a small spatial/temporal area. The viewers perception of each affected block will influence by other affected block in this small area. The invention proposes using processing means for clustering blocks affected by the packet loss into at least one cluster, for using at least one of spatial and temporal characteristics of the at least one cluster for determining a visibility value of the at least one cluster, for classifying the at least one cluster as belonging into one of at least two different class candidates, wherein each class candidate is associated with a different weight; for weighting the determined visibility value with the weight associated with the class of the at least one cluster, and for assessing the degradation of the video using a sum of the weighted visibility value.

TECHNICAL FIELD

The invention is made in the field of video quality assessment.

### BACKGROUND OF THE INVENTION

With the development of video compression, transmission, and storage, perceptual video quality is of great significance. For instance, determining the quality loss resulting from packet defect in transportation and/or storage of packed coded video can be of interest for, e.g. video distribution quality surveillance or video distribution services with video quality dependent charges.

Most precise and direct way for assessing video quality degradation is an averaging of subjective quality score assignments over a large group of individuals. But, subjective assignment is expensive and time-consuming. Thus, objective video quality measurement (VQM) has been proposed as an alternative method, in which it is expected to provide a calculated score as close as possible to the average subjective score, also called mean observer score (MOS). This score calculation can make use of artefacts detected on a per block basis in the video to-be-assessed, in particular, in case that no reference or only a reduced reference is available, but even in case full reference is available.

A number of researchers have addressed issues related to the relationship between data loss and user perception. For qualitative analysis, Lopez, D., Gonzalez, F., Bellido, L., and Alonso, A., “Adaptive multimedia streaming over IP based on customer oriented metrics,” in 2006 International Symposium on Computer Networks, 2006 studied the different packet loss patterns and their impact. Verscheure, O., Frossard, P., and Hamdi, M., “User-oriented QoS Analysis in MPEG-2 Video Delivery,” Real-Time Imaging, 1999, studied the impact of bit rate, packet loss and their combined impact on MPEG-2 video quality. For quantitative analysis, S. Qiu, H. Rui, and L. Zhang, “No-reference perceptual quality assessment for streaming video based on simple end-to-end network measures,” International Conference on Networking and Services, July 2006, used strong spatial discontinuities as hints of packet losses, and evaluated perceptual distortions based on the evaluation of these discontinuities. In the latter work, strong spatial discontinuities are used as hints of packet losses, and evaluated perceptual distortions based on the evaluation of these discontinuities.

For MOS prediction using detected artefacts at block level, pooling of detected artefacts is required. Pooling refers to a procedural step of combining information acquired for individual items, such as artefacts detected in blocks, and representative of the effects of the individual items, such as distortions in the blocks, into consolidated information representative of the overall effect of all items combined, such as overall quality degradation of a video.

That is, pooling strategy is to provide a single value to indicate an overall characteristic or characteristic change, e.g. quality or quality degradation, of multimedia content, e.g. video or audio, using information, e.g. artefact levels, for every separate sub-items of the content, e.g. blocks if images. A simple and easily implementable example of pooling of uniformly distributed artefacts is to add up all the artefacts in the blocks of the video.

### SUMMARY OF THE INVENTION

The inventors recognized that prior art pooling neglects spatial and temporal characteristics of artefacts and their effects on human vision. That is the inventors recognized that, because of the encoding, decoding, and/or transmitting characteristic, the blocks affected by packet defect usually gathered in a small spatial/temporal area. The viewer perception for each affected blocks will influence each other in this small area.

Therefore, in this invention, a more accurate pooling strategy according to human vision property is developed.

The invention proposes a cluster based pooling approach which takes into account at least one of spatial and temporal characteristics. Using this cluster based pooling strategy leads to predicted mean observer scores which better fit a mean of observer scores assigned by human subjects.

That is, a method according to claim 1 is proposed for assessing packet defect caused degradation in packet coded video, the method using artefact features detected at block level. Said method comprises using processing means for clustering blocks affected by the packet loss into at least one cluster, for using at least one of spatial and temporal characteristics of the at least one cluster for determining a visibility value of the at least one cluster, for classifying the at least one cluster as belonging into one of at least two different class candidates, wherein each class candidate is associated with a different weight; for weighting the determined visibility value with the weight associated with the class of the at least one cluster, and for assessing the degradation of the video using a sum of the weighted visibility value.

The features of further advantageous embodiments are specified in the dependent claims.

### BRIEF DESCRIPTION OF THE DRAWINGS

Exemplary embodiments of the invention are illustrated in the drawings and are explained in more detail in the following description. The exemplary embodiments are explained only for elucidating the invention, but not for limiting the invention's disclosure or scope defined in the claims.

In the figures:

FIG. 1 depicts examples of artefacts resulting from packet defect: FIG. 1 (a) depicts exemplary effects of error concealment in response to a packet loss; FIG. 1 (b) depicts exemplary error propagation

FIG. 2 provides a schematic depiction of spatial and temporal characteristics or features of an exemplary swarm: FIG. 2 (a) depicts exemplary spatial characteristic and FIG. 2 (a) depicts exemplary temporal characteristic; and

FIG. 3 depicts examples of merging and splitting: FIG. 3 (a) depicts a first exemplary pair of swarms which can be merged into a single swarm; FIG. 3 (b) depicts a second exemplary pair of swarms which can be merged into a single swarm; and FIG. 3 (c) depicts an exemplary swarm which can be split into two swarms.

### EXEMPLARY EMBODIMENTS OF THE INVENTION

The invention may be realized on any electronic device comprising a processing device correspondingly adapted. For instance, the invention may be realized in a television, a mobile phone, a personal computer, a navigation system or a car video system.

In an embodiment, the invention proposes a new pooling technique of detected artefacts which depends on a spatial-temporal occurrence pattern of the artefacts in the video. The proposed pooling is a “swarm based” pooling which tries to mimic the human visual systems (HVS) different sensibility for artefacts in dependency on the size of connected areas in which artefacts occur as well as the development of such areas over time.

When a lot of blocks affected by packet defect are gathered in a small connected area, viewers cannot tell the exact number of total artefacts but only can give some classification such as “big swarm”, “medium swarm”, or “small swarm” which may refer to spatial size and/or temporal duration. The cumulated overall perception distortion caused by these artefacts deviates from simple summation of level values of all the artefacts.

Therefore, clusters or swarms are proposed as replacement. First, swarm can be defined independent from each other. I.e. there is no constraint that swarms should not be near or adjacent to each other though such swarms may be merged, in particular, for keeping the number of swarms at a level of human perception which allows for identifying each swarm. Viewers are then able to identify and remember the features of the swarm because the scale of the swarm matches the scale of human perception.

Swarms are clusters of blocks directly or indirectly, by error propagation through residual encoding, affect by packet defect, i.e. incomplete retrieval or reception of a packet or unavailability of the entire packet.

In an embodiment, swarms comprise all blocks affected by defect of a certain packet. In another embodiment, one swarm can comprise less but all blocks affected by defect of a certain packet, the remaining blocks being comprised in at least one different swarm. In yet another embodiment, blocks affected by defects of in several packets are comprised in one swarm.

That is, the invention is based on swarms related to and resulting from packet defect and proposes different embodiments for refinement of the swarms. The refinement is achieved by a step of swarm merging, a step of swarm splitting or a combination thereof.

Clustering as proposed creates entities which can be assigned with spatial and temporal characteristics such as size and duration of the entity.

This allows for a new pooling strategy using this characteristics for providing a single value which indicates an overall quality or quality degradation of the video, given the artefacts levels for blocks in the video.

In an embodiment, swarms are classified as being of one of two or more, e.g. five, different swarm types, the different swarm types having different weights of contribution, in pooling, to the overall perception distortion.

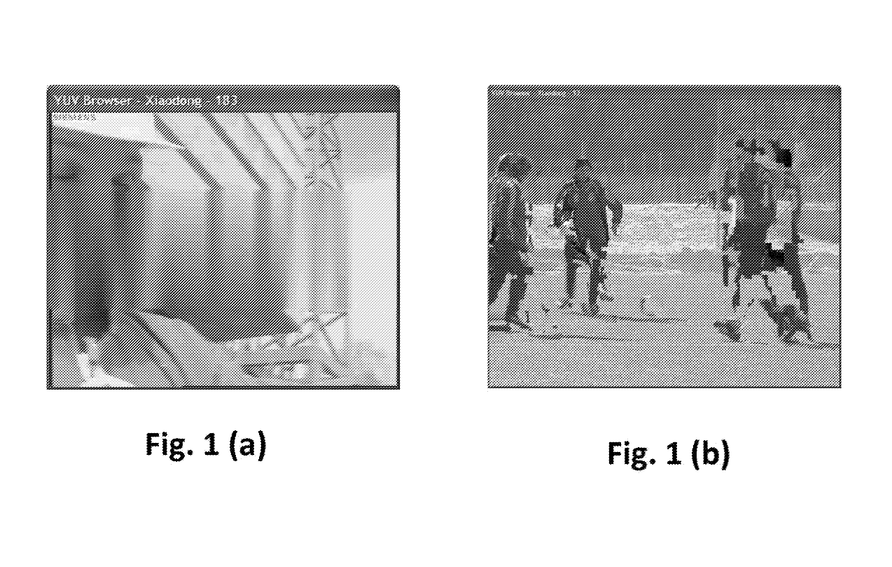

A single packet loss or partial defect affects an initial set of macro-blocks which can be subjected to error concealment. The artefacts in the initial set then can propagate to previous and/or following frames as a result of inter-frame prediction of video codec. The initial artefacts in the initial set are predictable as they are a direct result of the defect and/or the error concealment. Artefacts FIG. 1 (a) gives an example of such initial artefacts.

The types of artefacts resulting from propagation to previous and/or following frames as a result of inter-frame prediction of video codec are far more difficult to predict. An example of artefacts resulting from propagation is shown in FIG. 1 (b).

The types of the propagated artefacts are only indirectly resulting from the defect and/or the error concealment algorithm and may affect only a fraction of a block. Therefore, they are not always predictable. Fortunately, most codec provides some error control method. E.g. slicing is a common error control method in which several macro-blocks constitute a slice and the spatial prediction reference is restricted to the macro-blocks within the same slice. Error propagation is then terminated at the boundary of each slice in spatial axis. IDR is another exemplary error control method to terminate error propagation in the temporal axis.

With error control methods, the error propagation will be limited in a certain range and guaranteed not to be flooded.

A collection of blocks with visible initial artefacts caused by a single packet defect is called am initial swarm. The initial swarm combined with a collection of the blocks with visible artefacts caused by error propagation of the single packet's defect is called a packet swarm.

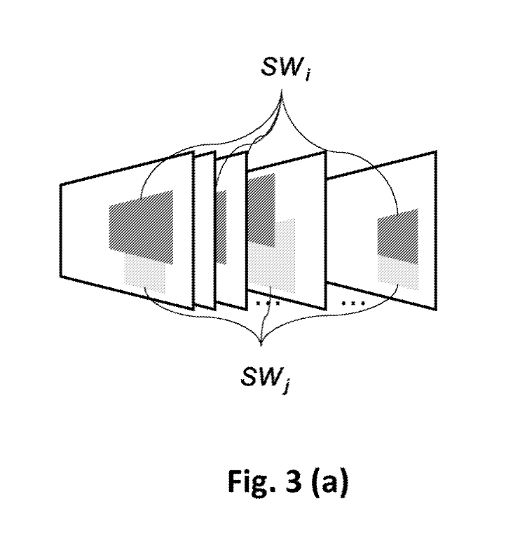

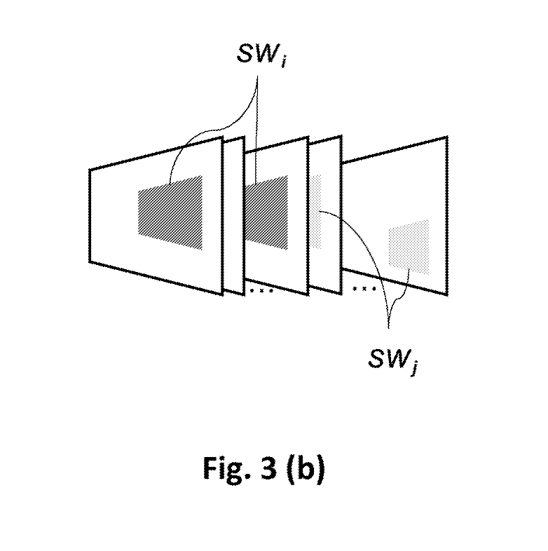

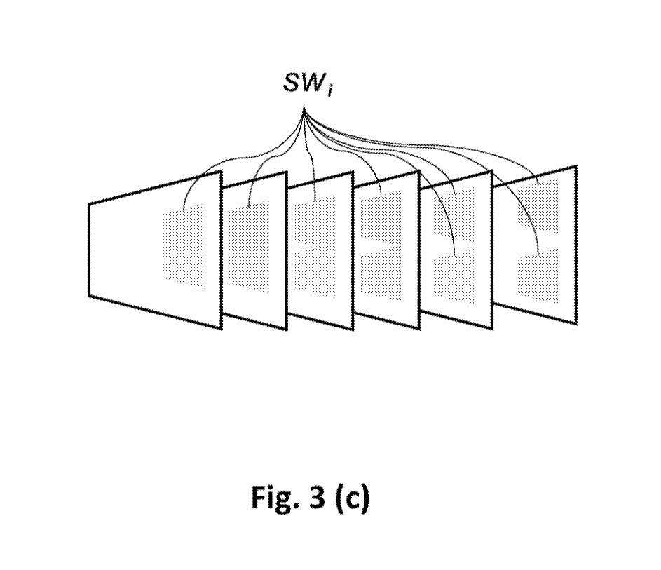

In an embodiment, different packet swarms comprising adjacent blocks in a same frame or in a contiguous sequence of frames can be fused or merged. A first situation where two swarms swᵢ and swⱼ may be merged is exemplarily shown in FIG. 3 (a). Similarly, a same block affected in successive frames by different packet defects can cause the corresponding packet swarms swᵢ and swⱼ to be merged as exemplarily shown in FIG. 3 (b). Or, the packet swarm comprising an affected block in the succeeding frame at a relative location corresponding to a continuation of a motion as indicated by a motion vector of an affect block in the preceding frame can be combined with the packet swarm of said block in the preceding frame. Furthermore, there is an embodiment where a single swarm swᵢ can be split into two or more swarms when parts of it propagate into different directions as exemplarily shown in FIG. 3 (b).

Let denote the video sequence V={Fᵢ} where Fᵢ is the i^{th} frame of the video, and Fᵢ={Bᵢⱼ} where Bᵢⱼ is the j^{th} block of frame Fᵢ.

And let denote P={pₘ}, is the m^{th} packet which is lost during transmission. For each lost packet pₘ, a packet swarm swₘ can be defined as a set of blocks. This set includes blocks for which a residual and/or a motion vector is affected by defect in packet pₘ. and blocks with perceivable artefacts which use block(s) in swₘ as reference, directly or indirectly, e.g. are predicted using these blocks or using blocks predicted by these blocks.

Let denote ALV(Bᵢⱼ) an artefact level value of block Bᵢⱼ. In an embodiment, the set can be limited to blocks which show perceivable artefacts, e.g. with an artefact level value ALV(Bᵢⱼ) at least as high as a perceptibility threshold th. The artefact level value ALV(swₘ) of a swarm is result of a pooling of the artefact level values of blocks in the swarm:

ALV(swₘ)=Σ_{B aus sw}_{_{—}}ₘ ALV(B)

If blocks which only show non-perceivable artefacts are not already excluded from the swarm, influence of their artefacts in pooling can be suppressed by appropriate weighting. But as the artefact level value of non-perceivable artefacts is low impact on pooling is limited anyway and suppression can be omitted.

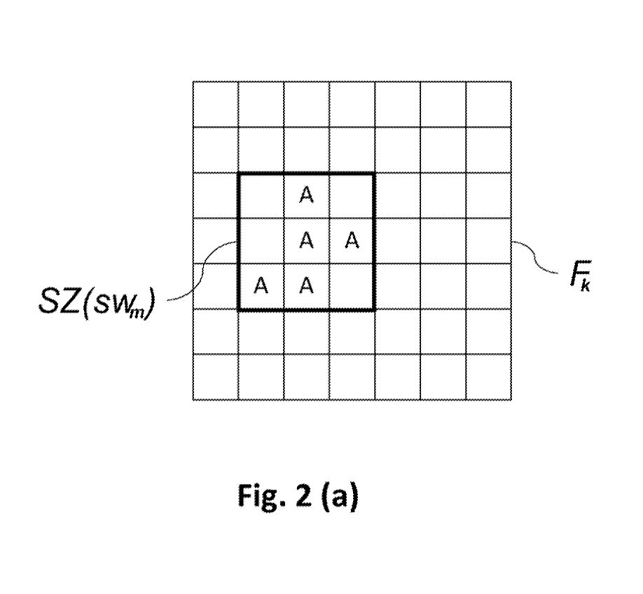

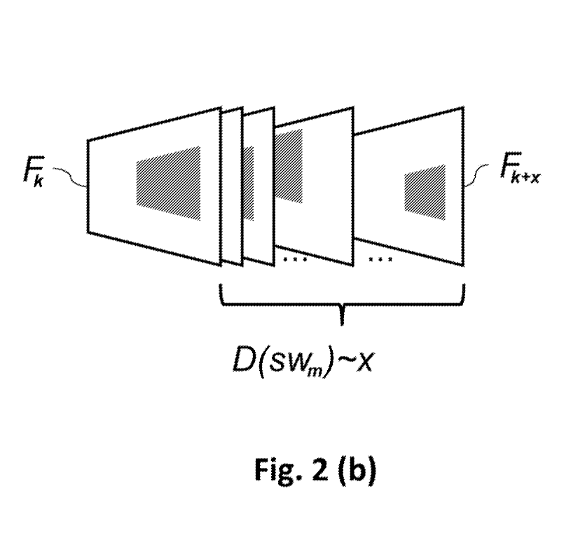

Further, let denote, as exemplarily depicted in FIG. 2(a), SZ(swₘ) a measure of the size of the minimal rectangle which covers the spatial locations of all the artefact blocks A in swarm swₘ, e.g. the number of blocks comprised in the minimal rectangle of frame Fₖ. Let denote, as exemplarily depicted in FIG. 2(b), D(swₘ) a measure of the maximal temporal distance between blocks in swarm swₘ, e.g. proportional to the number x−1 of affected frames between an earliest frame Fₖ and a latest frame Fₖ₊ₓ affected by the swarm. And let denote V(swₘ)=SZ(swₘ)*D(swₘ) the so-called “volume” of a swarm. These values SZ(swₘ) and D(swₘ) can be used for classifying the swarm swₘ, e.g. assign a class value C(swₘ) to the swarm swₘ using at least one of size and duration of the swarm, the class value C(swₘ) being associated with a weight coefficient w(C(swₘ)). The weight coefficients used in an exemplary embodiment was determined using a dataset of videos with mean observer scores determined based on subjective tests.

An embodiment of the proposed invention then determines an overall distortion or artefact level value of the video by weighted summation of the artefact level values of the swarms in the video, wherein each swarm's artefact level value is weighted by the weight coefficient associated with the class value assigned to the swarm using its spatial and/or temporal characteristic:

$$\begin{matrix}ALV ( VIDEO ) = {\sum }_{m} W ( C ( {SW}_{m} ) ) * ALV ( {SW}_{m} ) \\ = {\sum }_{i} {\sum }_{j} W ( C ( {SW}_{m} / {SW}_{m} comprises {B}_{ij} ) ) * ALV ( {B}_{ij} )\end{matrix}$$

In an exemplary embodiment, a binary classification of swarms in small swarms and big swarms is realized. To be classified as a big swarm, a swarm lasting longer than a predetermined duration threshold th_{D} specifying a number of frames, D(swₘ)>th_{D}, is classified as a big swarm. In a further exemplary embodiment, a swarm with a volume of at least a predetermined number of blocks th_{V}, V(swₘ)>th_{V}, is classified as a big swarm. In yet a further exemplary embodiment, a swarm with an artefact density, the swarm's artefact level value divided by the swarm's volume at least as high as a predetermined artefact density threshold th_{A}, ALV(swₘ)/V(swₘ)>th_{A}, is classified as a big swarm. Even yet further exemplary embodiments combine two of the criteria for classification as a big swarm. An exemplary embodiment using all three criteria further used th_{D}=2 and th_{V}=19, and set w(C(swₘ))=c₀ in case of C(swₘ))=0 and set w(C(swₘ))=c₁ in case of C(swₘ))=1 with c₁<>c₀, c₀ and c₁ being comprised in [0; 1].

The decision of c₀ and c₁ is an optimization problem, to maximize the value of the Pearson's sample correlation which is obtained by dividing the covariance of the mean observer score and the predicted score by the product of their standard deviations:

|PC(MOS, PRED(ALV(c₀, c₁))|

MOS is a sample vector of subjective mean scores assigned to given videos in a data base and PRED(ALV(c1, c1))) is a sample vector of predicted scores derived artefact level values calculated using the given videos in the data base. Pearson's sample correlation is the correlation between these two vectors. Pearson's sample correlation is a suitable measure for determining prediction accuracy.

Solve the optimization problem in an exemplary dataset, the prediction accuracy reaches maximum for c₀=0.9, and c₁=0.1. wherein the maximum reached is by 10 percent higher than the maximum reachable with a pooling which indiscriminatingly adds up all the artefacts in the blocks of the video.

The exemplary data base comprises six CIF format video contents, which cover a wide range of spatial complexity index and temporal complexity index, namely Foreman, Hall, Mobile, Mother, News, and Paris. The six sequences are encoded using H.264 encoder with two sequence structures, IBBP and IPPP. Group of Picture (GOP) size (i.e. the length between two IDR frames) is 15 frames. A proper fixed quantization parameter is used to prevent the compressed video from visible coding artefacts. Each row of macro-blocks is encoded as an individual slice, and one slice is encapsulated into a RTP packet. To simulate transmission error, loss patterns generated at five packet loss rates (PLRs) [0.1%, 0.4%, 1%, 3%, 5%] are used to generate error bitstream, which is decoded by ffmpeg decoder to generate PVSs (processed video sequences) for viewers to perform subjective scoring as well as for automatic MOS prediction.

A more complex exemplary embodiment uses for classification the following five classes, each with a corresponding different weight:

Imperceptible: “no artefact (or problematic area) can be perceived during the whole video display period”, e.g. all of swarm size, swarm duration and artefact density in the swarm are below corresponding thresholds.

Perceptible but not annoying: “artefact(s) can be perceived occasionally, but don't influence the interested content, or it appears in the background for an instant moment”, e.g. swarm size and swarm duration are below corresponding thresholds.

Slightly annoying: “noticeable artefact appear in the region of interest (ROI), or noticeable artefacts are detected for several instant moments even if they do not appear in the ROI”, e.g. artefact density in the swarm and one of swarm size and swarm duration are below corresponding thresholds.

Annoying: “noticeable artefact appears in ROI for several times or many noticeable artefacts are detected and last for a long time”, e.g. artefact density in the swarm is below a corresponding threshold.

Very annoying: “video content cannot be understood well due to artefacts and the artefacts spread all over the sequence”, e.g. none of e.g. swarm size, swarm duration and artefact density in the swarm is below a corresponding threshold.

There is an exemplary embodiment of the invention where a swarm based pooling strategy is used to evaluate the overall quality of a video which is degraded by packet loss, given the artefact level of all the blocks in the video. In the used pooling strategy, at first the blocks with perceivable artefacts are grouped into clusters, so-called swarms, according to their spatial/temporal locations. Then each swarm is classified and assigned a weight coefficient depending on the classification. Contribution of each swarm to the overall quality degradation is determined by multiplying the sum of the artefact levels of all blocks in the swarm by the assigned weight coefficient. Finally contributions of all the swarms are added up to determine the overall quality degradation.

1. A method for assessing packet defect caused degradation in packet coded video, the method using artefact features detected at block level and comprising using processing means:
for clustering blocks affected by the packet loss into at least one cluster,
for using at least one of spatial and temporal characteristics of the at least one cluster for determining a visibility value of the at least one cluster,
for classifying the at least one cluster as belonging into one of at least two different class candidates, wherein each class candidate is associated with a different weight;
for weighting the determined visibility value with the weight associated with the class of the at least one cluster, and
for assessing the degradation of the video using a sum of the weighted visibility value.

2. Method of claim 1, wherein clustering comprises
(a) initializing the at least one cluster using the blocks in which perceivable artefacts resulting from the packet loss are detected;
(b) determining blocks not-yet-comprised in the at least one cluster which are predictive encoded using at least one block of the cluster and adding the determined blocks to the cluster, and
(c) repeating step (b) until all blocks predictive encoded using blocks of the cluster are comprised in the cluster.

3. Method of claim 2, further comprising determining that the at least one cluster comprises, in an earliest or a latest frame, at least two non-adjacent rectangles each covering image locations of a sub-set of the packet loss affected blocks in that frame, and splitting the at least one cluster into at least two clusters corresponding to the rectangles.

4. Method of claim 1, wherein the spatial characteristics is a spatial size of the at least one cluster, the spatial size being dependent on a size of a rectangle which covers all image locations of blocks in the cluster, and wherein the temporal characteristics is a duration of the at least one cluster, the duration being dependent on a number of frames between an earliest occurring block and a latest occurring block of the blocks comprised in the cluster.

5. Method of claim 4, further comprising merging clusters which are spatially adjacent to and at least partly synchronous with each other.

6. Method of claim 4, further comprising merging clusters which cover same image locations in successive frames.

7. Device for assessing packet defect caused degradation in packet coded video, the device comprising:
means for detecting artefact features at block level;
means for clustering blocks affected by the packet loss,
means for determining a visibility value of the at least one cluster using at least one of spatial and temporal characteristics of the at least one cluster,
means for classifying clusters as belonging into one of at least two different class candidates, wherein each class candidate is associated with a different weight;
means for weighting the determined visibility value with the weight associated with the class of the at least one cluster, and
means for assessing the degradation of the video using a weighted sum of the visibility values of the clusters weighted by the weights of classes of the clusters.
